(19) United States
(12) Patent Application Publication
(10) Pub. No.: US 2002/0153395 A1
(43) Pub. Date: Oct. 24, 2002

(54) Apparatus and method for controlling use of a knife

(75) Inventor: Michael A. Martinez, Albuquerque, NM (US)

Correspondence Address: MICHAEL A. MARTINEZ, 218 COLUMBIA, S.E., APT. B, ALBUQUERQUE, NM, 87106, US

(73) Assignee: The Group Design, Inc., Albuquerque, NM

(21) Appl. No.: 09/838,448

(22) Filed: Apr. 19, 2001

(51) Int. Cl. B26B 29/02

(52) U.S. Cl. 224/232; 224/197; 224/666; 224/272

(57) ABSTRACT

An apparatus and method for controlling use of a knife is provided that includes a positionable detent mechanism. The detent mechanism is provided with a plate fixedly attached to a sheath. A hollow post with internal threads is inserted into the plate. A cavity is formed in the plate for holding a ball bearing and a wafer. The positionable detent mechanism also includes a disk with an orifice at the center that can be positioned over the post. Pegs are installed on the disk. Also, the disk includes a tapped hole and cap. A sheath is connected to the detent mechanism for holding the knife. A block is connected to the detent mechanism for orienting the sheath. A clip is provided for securing the apparatus on a belt or other object.

### FIELD OF THE INVENTION

The present invention pertains generally to an apparatus and method for controlling use of a folding tool. More particularly, the new and useful invention claimed in this document pertains to a system for safe but single-handed manipulation and use of a folding knife. The present invention is particularly, but not exclusively, useful for removing, using, and storing a folding knife for use with one hand.

### BACKGROUND OF THE INVENTION

Beginning in the 18^{th} century, technological advancements in forging metals that could hold sharp edges when formed into knife blades inaugurated significant alteration of the design, manufacture, and use of knives. What had been primitive tools started to become diverse, formidable, and even elegant implements. In recent decades, advancements in knife manufacturing technology has accelerated. Numerous companies and individuals now are devoted exclusively to design and manufacture of a wide variety of knives for work, sport, and even just collecting.

In the 21st Century, many blades are manufactured from stainless steel, particularly martensitic stainless steels. Most blades include a wide variety of chromium, imparting corrosion resistance, and carbon, permitting great degree of hardening by heat treatment. Edge retention of knife blades increases with higher carbon content; corrosion resistance is increased by higher chromium content. The many kinds of knives have a variety of distinctive uses. The blade of a knife is the major determining factor in the work to which the knife may be applied. The blade also is the chief concern in connection with safe use. Cost of a knife also is determined by the quality of the blade steel, workmanship, material used in forming a handle for the knife, and ornamentation. A knife blade generally is forged from steel into a desired shape, hardened and tempered, ground to a cutting edge and to remove all traces of forging and heat treatment, polished, and fitted to a handle. A wide variety of materials is used for handles, including horns and tusks, various woods, and bone. Handles also are manufactured from non-natural materials including plastics.

A major choice for a user of a knife is between a fixed-blade or a folding knife. Folding knives, also called “folders,” are usually selected on the basis of the intended use, as well as preference. Folding knives are lightweight, versatile, and easily carried. When open, blades of folding knives may be locked in operative position as a result of a variety of locking mechanisms. Releases for the locking mechanisms on some folding knives generally are located along the back of the handle to hold the knife open or closed with a spring, tab, or notch, or a combination of all mechanisms. In other words, most knife designers and manufacturers have focused on the knife, rather than on a carrier such as a sheath used to hold or store the knife, to control use and deployment of a knife blade using a single hand.

However, most designs and apparatus for controlling use of a folding tool, such as a folding knife, have proven to be expensive, unsafe, and mechanically unreliable. In addition, the user of a folding knife that is designed to rely on internal mechanisms in the knife to provide single-handed control and use of the knife, may be required to use two hands, rather than one, to open and close the blade due to the complexity of such mechanisms.

Safety is a considerable argument in favor of folding knives among those who prefer a folding knife. Fingers must be placed in the path of the blade as it is folded into place in the handle gap. A folding knife is inherently safer than an open knife. Besides being difficult to close, however, folders may open or close unexpectedly, especially if the spring, tab, or notch mechanism is over-stressed.

Considerable effort also has been devoted to design and manufacture of handles associated with knives. Many designs have been attempted to include in handles of a folding knife one or more mechanisms for opening and closing a blade in relation to the handle. Most current solutions require the use of two hands, rather than one.

Perhaps because makers and manufacturers of knives focus on knife design, rather than sheath design, the knife industry as a whole seems to have concluded that solutions for single-handled draw, and replacement of a folding knife into a sheath, resides in the design of the knife itself. Little effort has been devoted to designing a sheath, or accompanying mechanisms connectable to a sheath, to solve the problems associated with achieving single-handed removal, insertion, and storage of a knife using a sheath.

The limitations of the current state of the art become evident on using a knife, particularly a folding knife, and even more particularly if a user is attempting to deploy a knife using a single hand. Most mechanisms now associated with a folding knife are located in the knife, requiring the use of two hands. None of the mechanisms mounted on knives to implement single-handed use is safe or durable. A further limitation on current apparatus is that no device is provided for grasping, storing or holding the knife blade when not in use, other than the handle of the knife itself. An additional limitation is caused by the weakness of spring-loaded opening mechanisms on most conventional folding knives. Most spring-loaded opening mechanisms assist in opening a folding knife blade from a handle only a limited distance. Safety, obviously, is a major concern with the current state of the art.

Therefore, a previously unaddressed need exists in the industry for a new, useful and improved apparatus and method for controlling use of a knife, particularly a folding knife, that has the capability of providing single-handled deployment, use and storage. Particularly, there is a significant need for an apparatus and method that will ensure safety during use of a folding knife using only a single hand.

### SUMMARY OF THE INVENTION

Given the conventional solutions for solving the problem of single-handed use and control of a folding knife or similar tool, it would be desirable, and of considerable advantage, to provide an apparatus and method for controlling use of a folding knife during single-handed use of, and work with, a folding knife.

The present invention provides numerous advantages in connection with control of a folding knife during single-handed operation. At least one of the advantages of the present invention is that it provides a safe but inexpensive solution to the problems.

Another significant advantage of the present invention is that it provides ambidextrous use. Most knives and sheaths are designed in contemplation of right handed use. The present apparatus and method for controlling use of a folding knife during single-handed use, however, includes structural elements that cooperate with a folding knife to enable either a right handed or left handed person to operate the invention, without any modification of the invention.

In addition, structural elements are provided with the present invention that, contrary to current sheaths, permits use and storage of knives having heavier than usual handles.

Another advantage of the present invention is elimination from a knife of delicate spring mechanisms and similar unsafe and unreliable closing mechanisms.

Yet another advantage of the present invention is an apparatus and method for single-handled operation of a folding tool, such as a folding knife, that relies primarily on the sheath, rather than on the knife itself. Because the sheath is rotatable by the user into many different positions, the user of the knife may position the sheath for a customized draw and reinsertion of the knife into the sheath.

Another advantage of the present invention is its ability to accommodate a wide variety of knife shapes and designs because of the configuration of the carrier, or sheath, included in the apparatus.

Still another advantage of the present invention is the ability to select a multiplicity of drawing positions that accommodate ergonomically the differing hand sizes, arm lengths, and similar physiological differences among users.

Yet another advantage of the present invention is its resistance to water and sunlight corrosion, even though it is manifestly affordable.

Still another advantage of the present invention is the ability to securely position and orient the apparatus during use and non-use.

These and other advantages are achieved in the present invention by providing both an apparatus and a method for single-handled operation of a folding tool, such as a folding knife, that includes a carrier for holding the folding knife. The carrier is primarily a sheath. The present invention also includes a unique manipulatable detent system. The manipulatable detent system consists primarily of two components, a plate mountable on the sheath, and a disk engagable with the plate. More specifically, the detent system provided by the present invention is a device for positioning and holding one mechanical part in relation to another, so that the device may be released by force applied to one of the parts. The plate is attached to a surface of the sheath. The plate is formed with an arcuate channel. At the ends of the arcuate channel, ramps are formed. An elevated surface is included between the ends of the arcuate channel, and in the elevated surface a cavity is formed. A hollow post is inserted into a duct of the plate. The hollow post is formed with threads in one end of the post. A spherical bearing, such as a ball bearing, is provided for insertion into the cavity. In addition, a wafer is installed over the bearing. As indicated, the manipulative detent system includes a disk. The disk is formed with an orifice substantially in the center of the disk so that the tubular surface of the post is slidably engagable with the orifice. In addition, the disk is formed with a plurality of pegs on one plane of the disk. A tapped hole is formed in one surface of the disk, and a cap that is threadably engagable with the tapped hole is provided. A block also is included. The grip block is demountably fastenable to the manipulatable detent system. A number of pyramidal protrusions are formed in one surface of the grip block, and arranged in asymmetrical formation, to assist in securing and orienting the apparatus. Means for securing the carrier, or sheath, on a user is provided, including a clip.

The advantages and other objects of the present invention, and features of such an apparatus and method for controlling use of a knife, will become apparent to those skilled in the art when read in conjunction with the accompanying following description, drawing figures, and appended claims.

Thus, it is clear from the foregoing that the claimed subject matter as a whole, including the structure of the apparatus, and the cooperation of the elements of the apparatus, as well as the method for practicing the apparatus, combine to result in a number of unexpected advantages and utilities of the present invention.

The foregoing has outlined broadly the more important features of the invention to better understand the detailed description which follows, and to better understand the contribution of the present invention to the art. Before explaining at least one embodiment of the invention in detail, it is to be understood that the invention is not limited in application to the details of construction, and to the arrangements of the components, provided in the following description or drawing figures. The invention is capable of other embodiments, and of being practiced and carried out in various ways. Also, the phraseology and terminology employed in this disclosure are for purpose of description, and should not be regarded as limiting.

As those skilled in the art will appreciate, the conception on which this disclosure is based readily may be used as a basis for designing other structures, methods, and systems for carrying out the purposes of the present invention. The claims, therefore, include such equivalent constructions to the extent the equivalent constructions do not depart from the spirit and scope of the present invention. Further, the abstract associated with this disclosure is neither intended to define the invention, which is measured by the claims, nor intended to be limiting as to the scope of the invention in any way.

The novel features of this invention, and the invention itself, both as to structure and operation, are best understood from the accompanying drawing, considered in connection with the accompanying description of the drawing, in which similar reference characters refer to similar parts, and in which:

### BRIEF DESCRIPTION OF THE DRAWING

FIG. 1 is a perspective view of the apparatus and method for controlling use of a knife in an operative environment;

FIG. 2A is a perspective view of the components of a preferred embodiment of the present invention;

FIG. 2B is a perspective view of the components of a preferred embodiment of the present invention from a different perspective;

FIG. 2C is a perspective and side view of the plate of the present invention;

FIG. 3A is a side view of the assembled components of the present invention; and

FIG. 3B is a top view of the assembled components of the present invention.

### DESCRIPTION OF THE PREFERRED EMBODIMENT

Briefly, the present invention provides an apparatus and a method for single-handled operation of a folding tool, such as a folding knife, that includes a carrier, such as a sheath, for holding the folding knife. The present invention also includes a unique manipulatable detent system that includes a plate formed with a channel having ramps at each end of the channel, a cavity, and a bearing that can move along the channel into the cavity. In addition, a wafer is installed over the bearing. The invention also includes a disk engagable with the plate. A hollow post is insertable into a duct in the plate. The hollow post is formed with threads in one end of the post. The disk is formed with an orifice so that the tubular surface of the post is slidably engagable with the orifice. The disk also is formed with a plurality of pegs on one plane of the disk. A tapped hole is formed in one surface of the disk, and a cap that is threadably engagable with the tapped hole is provided. As provided in the present invention, a block also is included that is demountably fastenable to the manipulatable detent system. A number of pyramidal protrusions are formed in one surface of the grip block, and arranged in asymmetrical formation, to assist in securing and orienting the apparatus. Means for securing the carrier, or sheath, on a user is provided, including a clip.

The present invention, therefore, is useful for controlling use of a folding knife during single-handed use and work.

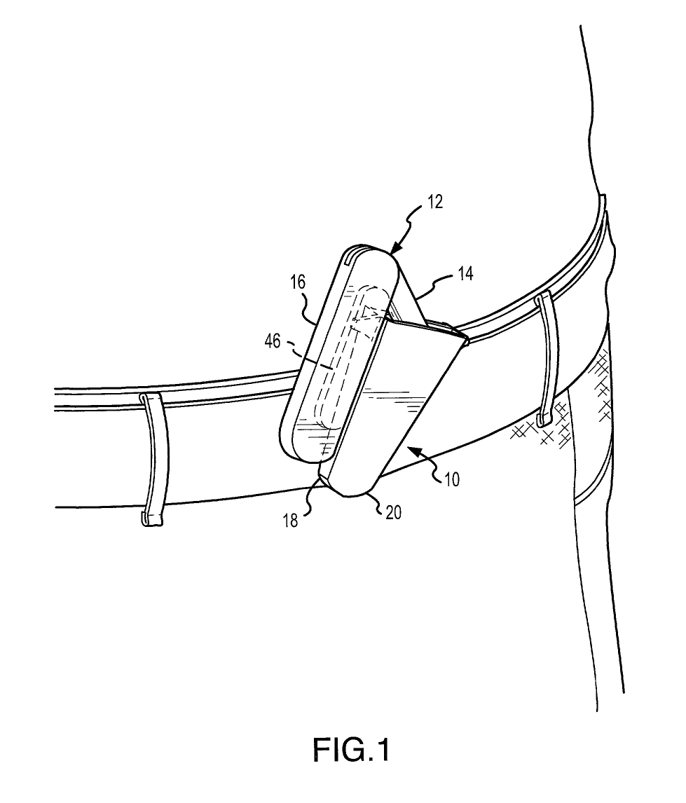

Specifically, FIG. 1 shows an apparatus for controlling use of a folding tool 10 in an operative position on a user of apparatus 10. Specifically, FIG. 1 shows a folding knife 12, having a blade 14 and a handle 16. Also shown in FIG. 1 is a carrier 18 for holding the folding knife (also referred to as a “knife”) when not in use.

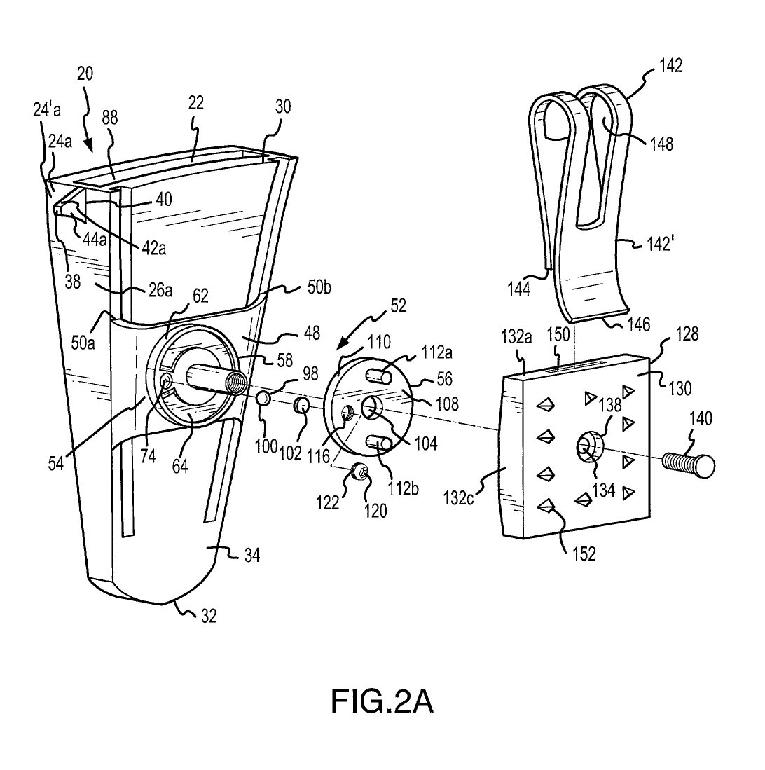

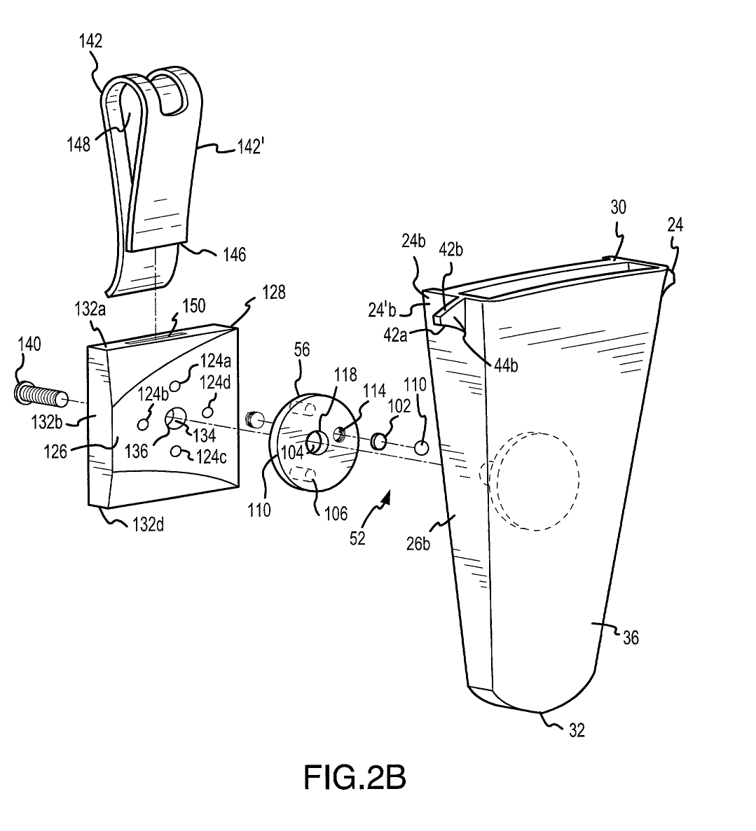

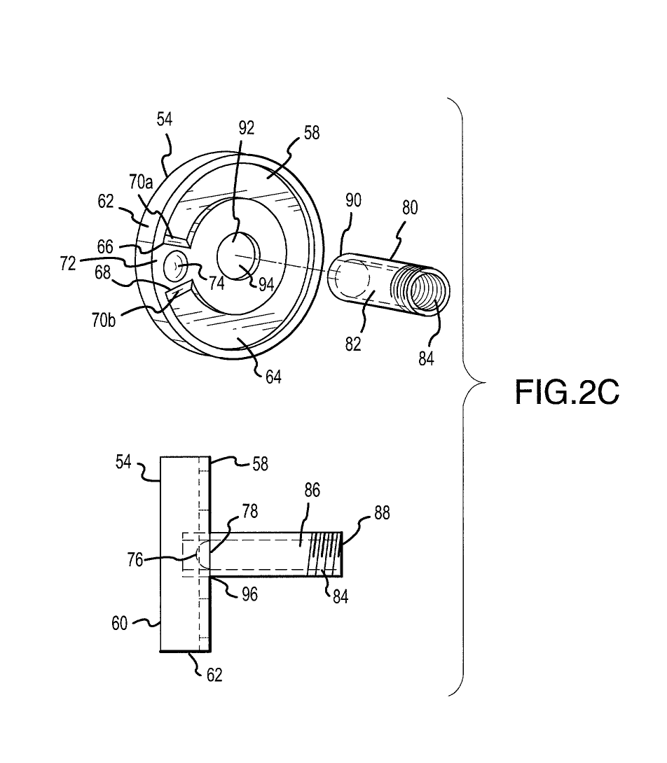

As also shown in FIG. 2A, the present invention includes carrier 18. In a preferred embodiment of the present invention, carrier 18 for holding folding knife 12 is sheath 20. Materials used in the manufacture of the sheath are not a limitation on the present invention. In a preferred embodiment of the present invention, however, sheath 20 is made from water-resistant ultraviolet protected plastic or similar resins. Sheath 20 is formed with a chamber 22, as also shown in FIG. 2A. Chamber 22 is used for storing or inserting blade 14 of knife 12. The size and dimensions of chamber 22 are not material limitations on the present invention, and may be formed and configured to accommodate a wide variety of lengths, shapes and dimensions of blade 14 to pinch or secure blade 14 within chamber 22.

Sheath 20 further includes a plurality of flanges 24a,b, as shown by cross-reference between FIGS. 2A and 2B. Flanges 24a,b are mounted on opposing walls 26a,b substantially adjacent the open end 28 of chamber 22. Sheath 20 is formed with a top end 30, a bottom end 32, as well as a first surface 34 and a second surface 36, as shown perhaps best by cross-reference between FIG. 2A and FIG. 2B. In a preferred embodiment of the present invention, each of the plurality of flanges 24a,b is shaped substantially in the form of a trapezoid to form a plurality of trapezoidal shaped flanges 24′. Each of the trapezoidal flanges 24′a,b is formed with an upper surface 38, a lower surface 40, opposing sides 42a,b, and opposing facets 44a,b As shown, lower surface 40a,b of trapezoidal flanges 24′a,b is fixedly connected to opposing walls 26a,b of sheath 20. In a preferred embodiment of the apparatus for controlling use of a folding tool 10, trapezoidal flanges 24′a,b are formed in situ in opposing walls 26a,b of sheath 20 in such a manner that lower surface 40a,b does not exist. As will be evident to a person skilled in the art, the shape of flanges 24a,b is not a material limitation on the present invention. Any number of alternative shapes of flanges 24a,b may be used instead of trapezoidal flanges 24′a,b, depending in part on the shape and dimensions of handle gap 46 in handle 16 of folding knife 12, and on the weight of handle 16 and blade 14.

Plurality of trapezoidal flanges 24′a,b engages a handle gap 46, as shown best in FIG. 1, to further secure the storing of knife 12 in chamber 22 of sheath 20. A significant advantage of flanges 24′a,b are their ability to cooperate with the other structural elements of the present invention to provide ambidextrous use. Most conventional knives and sheaths are designed in contemplation of right handed use. The present apparatus and method for controlling use of a folding knife 10 during single-handed use, however, includes flanges 24′a,b to cooperate with knife 12 to enable either a right handed or left handed person to operate the invention, without any modification of the invention. In addition, flanges 24′a,b permit use and storage of a knife 12 having heavier than usual handle 16 because flanges 24′a,b will hold a heavy handle 16 in place. As shown also in FIG. 2A, in a preferred embodiment of the present invention, apparatus for controlling use of a knife 10 also includes a bowed rib 48. Opposing ends 50 a,b ofbowed rib are fixedly attached to the intersections of opposing walls 20a,b and first surface 34 of sheath 20.

As further shown by cross-reference between FIGS. 2B and 2C, the present invention includes a manipulatable detent system 52. Manipulatable detent system 52 includes a plate 54 and a disk 56. Plate 54 is fixedly attached to first surface 34 of sheath 20. Plate 54 includes an outer surface 58, an inner surface 60, and a collar 62 therebetween. As best shown in FIG. 2C, a channel 64 having a first end 66 and a second end 68 is formed in outer surface 58 of plate 54. In a preferred embodiment of the present invention, channel 64 is shaped as an arcuate channel. As will be evident to a person skilled in the art, the shape of channel 64 is not a limitation of the present invention. A ramp 70a,b is formed in first end 66 and second end 68 of arcuate channel 64. Ramp 70a and ramp 70b define an elevated surface 72 on outer surface 58 of plate 54. A cavity 74, substantially hemispherical in shape, is formed in elevated surface 72. Cavity 74 is formed with a concave distal end 76 and a proximal end 78 that is substantially planar with elevated surface 72.

The present invention also includes, as shown best by cross-reference between FIGS. 2A and 2C, a hollow post 80. Hollow post 80 is formed with a tubular surface 82. Hollow post 80 also is formed with threads 84 within the lumen 86 of hollow post 80. Hollow post 80 is further formed with a leading end 88 and a following end 90, as best shown in FIG. 2C. In a preferred embodiment of the present invention, hollow post 80 provides a cross-section through tubular surface 82 that is substantially circular. As will be evident, however, to a person skilled in the art, such a cross-section or shape of hollow post 80 is not a limitation on the present invention, and any shape or cross-section may be used to practice the invention. As shown best in FIG. 2C, plate 54 also is provided with a duct 92. Duct 92 is formed in plate 54 with an inner end 94 and an outer end 96. Following end 90 of hollow post 80 is fixedly insertable against inner end 94 of duct 92 substantially coincident with the longitudinal axis through the center of plate 54. As also shown, perhaps best in FIG. 2A, a bearing 98 is provided. In a preferred embodiment of the present invention, bearing 98 is a spherical ball bearing 100. The shape, however, of bearing 98 is not a limitation of the present invention, and any of a number of shapes may be used to practice the invention. Also included as a component of manipulatable detent system 52 of the present invention is a wafer 102, as shown best in FIG. 2A.

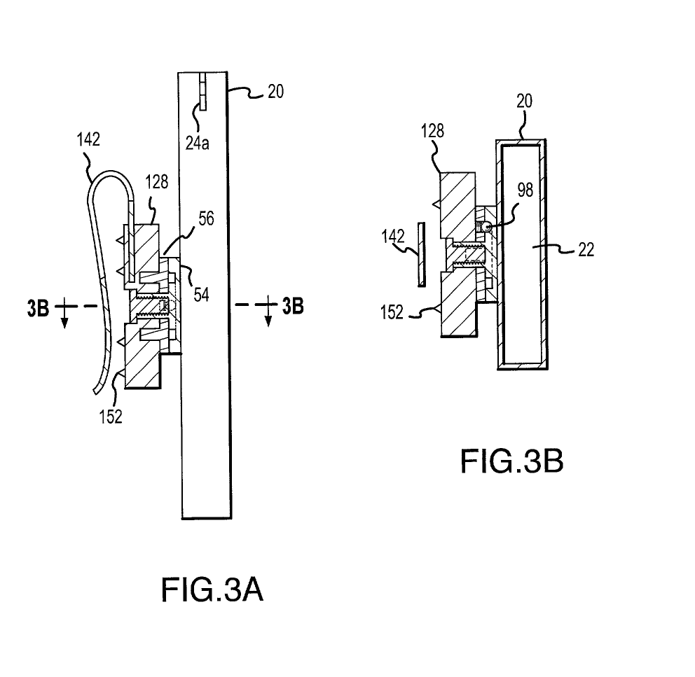

As also shown in FIG. 2A, and by cross-reference between FIGS. 3A and 3B, is disk 56 that is included in manipulatable detent system 52. Disk 56 is formed with an orifice 104 substantially in the center of disk 56. Alternatively, orifice 104 may be located in a location other than substantially in the center of disk 56. By forming orifice 104 off axis or eccentrically, alternative positioning locations may be provided during rotation and positioning of the invention during use. Orifice 104 is included for slidable engagement of disk 56 with tubular surface 82 of post 80 in plate 54. Disk 56 is formed with a first plane 106 and a second plane 108, with a sleeve 110 therebetween. As shown in FIG. 2A, a plurality of pegs 112 a,b are formed in second plane 108 of disk 56. Plurality of pegs 112 a,b are mounted substantially perpendicular to second plane 108 of disk 56. In addition, orifice 104 is formed substantially through the center of disk 56 between first plane 106 and second plane 108 of disk 56.

As shown by cross-reference between FIGS. 2A and 2C, a tapped hole 114, formed with a junior end 116 and a senior end 118, is formed between first plane 106 and second plane 108 of disk 56. Tapped hole 114 is located on disk 56 such that the longitudinal axis through the center of tapped hole 114 is substantially coincident with the longitudinal axis through cavity 74 on elevated surface72 of plate 54. Orifice 104 in disk 56 is slightly larger than, but slidably engagable with, tubular surface 82 of post 80. In addition, pegs 112a,b are mounted on first plane 106 of disk 56 to be substantially perpendicular to second plane 108 of disk 56. In a preferred embodiment of the present invention, pegs are positioned such that the longitudinal axis of peg 112a is substantially directly opposite the longitudinal axis of pet 112b.

A cap 120 having at least one threaded end 122 for engagement with tapped hole 114 at junior end 116 of tapped hole 114 also is provided. In a preferred embodiment of the present invention, cap 120 is a slot head screw 120′. Plurality of pegs 112a,b on first plane 106 of disk 56 are provided for engagement with beveled bores 124 formed in a posterior face of block 128 more fully described below.

As further shown by cross-reference between FIGS. 2A and 2B, and also shown in FIGS. 3A and 3B, an apparatus for controlling use of a knife 10 as provided by the present invention also includes a block 128. Block 128 is formed with anterior face 130, posterior face 126, and four opposing planes 132 a,b,c,d therebetween. As indicated, plurality of beveled bores 124 are formed in posterior face 126 of block 128. Plurality of beveled bores 124 may be chamfered adjacent posterior face 126, and are sized to be engagable with plurality of pegs 112 on first plane 106 of disk 56. An aperture 134 is formed through block 128 substantially in the center of block 128 and coincident with the longitudinal axis through the center of block 128 between anterior face 130 and posterior face 126 of block 128. Aperture 134 of block 128 is formed with a forward end 136 and a rear end 138. Chamfered recesses may be formed in forward end 136 of aperture 134 of block 128. A threaded connector 140 is included in the present invention for insertion through aperture 134 of block 128, through orifice 104 of disk 56, and engagable with internal threads 84 of post 80 mounted on plate 54. In a preferred embodiment of the present invention, threaded connector 140 is a slotted king pan head screw. While shape and dimensions are not material limitations on the present invention, in a preferred embodiment of the present invention, slotted king pan head screw is approximately ½ inch in length.

As further shown in FIGS. 2A and 2B, as well as in FIGS. 3A and 3B, a lap-over band 142 is provided. Lap-over band 142 is formed with an exposed end 144 and an inserted end 146, and a notch 148 therebetween. Inserted end 146 of lap-over band 142 is slightly curved. Inserted end 146 of lap-over band 142 is insertable into slot 150 formed in block 128. In a preferred embodiment of the present invention, lap-over band is a spring steel belt clip 142′.

### OPERATION

In operation, apparatus and method for controlling use of a knife 10 solves a significant problem in the industry by providing single-handed opening, closing and storing of folding knife 12. In the absence of the present invention, there is no reliable or safe method for safely opening, using, closing, and storing a folding knife 12 using one hand. In combination, carrier 18, or sheath 20, plate 54 fixedly attachable to sheath 20, disk 56, block 128, and clip 142′ provide a system for smoothly utilizing a knife, particularly folding knife 12, rapidly releasing knife 12 for use, and safely and predictably sheathing knife 12 when not in use. Sheath 20 is adapted for forward and backward sheathing of knife 12, particularly blade 14, for a variety of knife blade configurations.

Also in operation, blade 14 is insertable into sheath 20, and handle 16 folds outside of sheath 20 to be secured while not in use by at least one flange 24a,b which act as handle grippers by engaging handle gap 46 in handle 16. Knife 12, when stored in sheath 20, is in a partially opened position as shown in FIG. 1, but is secured and ready for removal, or to draw. As shown, the at least one flange 24a,b contribute to providing an invention that permits ambidextrous use, namely use by a right or left handed person. Plate 54 on bowed rib 48 of first surface 34 of sheath 20 provides interior threaded post 80 protruding from substantially the center of plate 54. At the base of post 80, arcuate channel 64 ends in ramps 70 a,b that lie on either side of cavity 74. Arcuate channel 64 provides bearing 98 an area in which to traverse when manipulatable detent system 52 is rotated, and eliminates drag on bearing 98. Thus, in operation, as bearing 98 rotates through the area provided by arcuate channel 64, bearing 98 comes in contact with one or more ramps 70 a,b, ascends ramp area 70a or 70b, and lodges temporarily in cavity 74.

Disk 56 is slidably engagable with tubular surface 82 of post 80. Orifice 104 of disk 56 may be provided in a slightly larger diameter than the diameter of post 80 to enable disk 56 to independently rotate around post 80. In combination, tapped hole 114, cap 120, wafer 102, and bearing 98 perform as a rotatable, repositionable spring device. Cap 120, when threaded into tapped hole 114, applies pressure on wafer 102 and bearing 98, forcing bearing 98 to protrude from first plane 106 of disk 56. During rotation of disk 56, bearing 98 comes in contact with ramp 70a or ramp 70b, is depressed, and rides ramp 70a or ramp 70b into cavity 74, where bearing 98 is forced into cavity 74. In operation, therefore, plate 54 and disk 56 are temporarily locked together, depending on the angle or orientation desired by the user of apparatus for controlling use of a knife 10.

Considering now the operation of the second plane 108 of disk 56 in combination with block 128, plurality of pegs 112 may be strategically mounted substantially opposite one another on second plane 108 of disk 56. Plurality of beveled bores 124 in posterior face 126 of block 128 provide receptacles for pegs 112a,b of disk 56. Beveled edges may be provided in beveled bores 124 to provide ease of mating between beveled bores 124 and pegs 112a,b. A user of the present invention may alter position and orientation of pegs 112a,b into different beveled bores 124, thus orienting or positioning sheath 20 to a customized and selected position user wishes to orient sheath 20 to draw knife 12 from sheath 20. The position and orientation of apparatus for controlling use of a knife 10 is achieved by inward force generated by clip 142 and by plurality of pyramidal protrusions 152 arranged in an asymmetric pattern to provide a more robust grip against whatever material user selects, such as a pocket or belt as shown in FIG. 1. Connector 140, insertable through aperture 134 of block, is engagable with internal threads 84 of post 80 in plate 54, to secure the components of apparatus 10 together, other than clip 142′ which slides into slot 150 of block 128.

While the apparatus and method for controlling use of a knife shown in drawing FIGS. 1 through 3B is one embodiment of the present invention, it is merely one embodiment of the invention, is not intended to be exclusive, and is not a limitation of the present invention. The particular apparatus and method for controlling use of a knife as shown and disclosed in detail in this instrument is fully capable of obtaining the objects and providing the advantages stated, but this disclosure is merely illustrative of the presently preferred embodiments of the invention, and no limitations are intended in connection with the details of construction, design or composition other than as provided and described in the appended claims.

What is claimed is:

1. A method for single-handed operation of a folding tool, comprising:
providing a carrier for holding the folding tool;
installing on the carrier a manipulatable detent system;
furnishing a grip block demountably fastenable to the manipulatable detent system; and
including means for securing the carrier on a user of the folding tool.

2. A method for single-handed operation of a folding tool as recited in claim 1, wherein the providing step includes the substeps of:
opening the folding tool;
closing the folding tool; and
storing the folding tool.

3. A method for single-handed operation of a folding tool as recited in claim 1, wherein the installing step includes the substeps of:
attaching to an initial surface of the carrier a plate formed with a channel having a first end, a second end, and an elevated surface therebetween;
forming in the first end and second end of the channel a ramp section;
including in the elevated surface a cavity formed with a concave distal end;
forming a duct in the plate;
inserting one end of a hollow post formed with a tubular surface into a duct substantially coincident with the longitudinal axis through the center of the plate;
forming threads within the other end of the post;
positioning a spherical bearing into the cavity; and
including a wafer at least one point of which is in contact with the spherical bearing.

4. A method for single-handed operation of a folding tool as recited in claim 3, wherein the installing step further includes the substeps of:
selecting a disk;
forming an orifice substantially in the center of the disk for slidable engagement with the tubular surface of the post;
installing a plurality of pegs on one plane of the disk;
including a tapped hole in the disk; and
providing a cap for threadable engagement with the tapped hole.

5. A method for single-handed operation of a folding tool as recited in claim 1, wherein the furnishing step includes the substeps of:
providing an anterior face and a posterior face on the grip block;
forming a plurality of beveled bores in the posterior face of the grip block;
including an aperture through the block substantially in the center of the grip block along the longitudinal axis between the anterior face and posterior face;
including a connector with an annular surface partially formed with threads; and
installing on the anterior surface a plurality of pyramidal protrusions.

6. A method for single-handed operation of a folding tool as recited in claim 1, wherein the including step further comprises the step of forming a band into a clip.

7. A system for controlling use of a folding knife, comprising:
a positionable detent mechanism;
means connectable to the positionable detent mechanism for holding the folding knife;
a block connectable to the positionable detent mechanism for orienting the holding means; and
a clip attachable to the block for securing the system on an object.

8. A system for controlling use of a folding knife as recited in claim 7, wherein the positionable detent mechanism includes a carrier plate fixedly attached to an initial surface of the carrier a plate.

9. A system for controlling use of a folding knife as recited in claim 8, further comprising a hollow post insertable into the carrier plate.

10. A system for controlling use of a folding knife as recited in claim 9, wherein the hollow post includes internal threads.

11. A system for controlling use of a folding knife as recited in claim 10, further comprising a cavity formed in a surface of the carrier plate.

12. A system for controlling use of a folding knife as recited in claim 11, further comprising a ball bearing insertable in the cavity.

13. A system for controlling use of a folding knife as recited in claim 12, further comprising a wafer in contact with the ball bearing.

14. A system for controlling use of a folding knife as recited in claim 7, wherein the positionable detent mechanism includes a disk.

15. A system for controlling use of a folding knife as recited in claim 14, further comprising an orifice in the disk.

16. A system for controlling use of a folding knife as recited in claim 15, wherein the disk includes a plurality of pegs installed substantially vertically one plane of the disk.

17. A system for controlling use of a folding knife as recited in claim 16, wherein the disk is formed with a tapped hole.

18. A system for controlling use of a folding knife as recited in claim 17, further comprising a cap threadably engageable with the tapped hole.

19. A system for controlling use of a folding knife as recited in claim 7, wherein the holding means is a sheath.

20. A system for controlling use of a folding knife as recited in claim 7, wherein the block includes a plurality of beveled holes for further orienting the holding means.

21. An apparatus for controlling operation of a knife, comprising:
a sheath, wherein the sheath further comprises a plurality of flanges engageable with the knife;
a plate fixedly attachable to the sheath, wherein the plate further comprises a post;
a disk slidably engageable with the post for orienting the sheath;
a block demountably positionable on the second plate for positioning the sheath; and
means attachable to the block for securing the apparatus.

22. An apparatus for controlling operation of a knife as recited in claim 21, wherein the plurality of flanges are engagable with a handle gap in the knife.

23. An apparatus for controlling operation of a knife as recited in claim 21, wherein the sheath further comprises a bowed rib for fixedly mounting the first plate.

24. An apparatus for controlling operation of a knife as recited in claim 21, wherein a cavity is formed in a surface of the first plate.

25. An apparatus for controlling operation of a knife as recited in claim 21, further comprising a bearing insertable in the cavity.

26. An apparatus for controlling operation of a knife as recited in claim 21, further comprising a wafer in contact with the bearing.

27. An apparatus for controlling operation of a knife as recited in claim 21, wherein the disk is substantially circular.

28. An apparatus for controlling operation of a knife as recited in claim 21, wherein the disk includes a plurality of pegs mounted on one plane of the disk for engagement with the block.

29. An apparatus for controlling operation of a knife as recited in claim 21, wherein the block further comprises a plurality of asymmetrically installed protrusions formed on a face of the block.

30. An apparatus for controlling operation of a knife as recited in claim 21, wherein the securing means is a spring steel clip.
